(19) United States
(12) Patent Application Publication
(10) Pub. No.: US 2016/0335816 A1
(43) Pub. Date: Nov. 17, 2016

(54) Automotive Inspection System using Network-Based Computing Infrastructure

(71) Applicant: Robert Bosch GmbH, Stuttgart (DE)

(72) Inventors: Vijai Thoppae, Canton, MI (US); Indermohan Sethi, Macomb Twp., MI (US)

(21) Appl. No.: 15/112,368

(22) PCT Filed: Jan. 23, 2015
(86) PCT No.: PCT/US2015/012606

§ 371 Date: Jul. 18, 2016

Related U.S. Application Data
(60) Provisional application No. 61/931,370, filed on Jan. 24, 2014.

(51) Int. Cl. G07C 5/08; H04L 29/08; H04L 29/06

(52) U.S. Cl. CPC G07C 5/0808; H04L 67/42; H04L 67/12; G07C 5/0841; G07C 5/0816

(57) ABSTRACT

A connected service for automotive diagnostics offers an integration layer that forms a back bone to enable communication and dataflow that will allow technician to perform inspection and store the data in central data storage system. The system optionally includes integration with electronic multi-point inspection software. The system includes network services that enable establishment of a connection service framework that is compatible with diagnostic equipment from multiple manufacturers, a secure web administration console that allows both OEM & dealers to configure new equipment, select equipment, scan VIN & view completed results, and integration with equipment vendors based upon a standard web service contract.

### CLAIM OF PRIORITY

This application claims priority to U.S. Provisional Application No. 61/931,370, which is entitled “Automotive Inspection System Using Network-Based Computing Infrastructure,” and was filed on Jan. 24, 2014, the entire contents of which are hereby incorporated by reference herein.

### TECHNICAL FIELD

This disclosure relates generally to automotive maintenance systems and, more particularly, to automotive diagnostic systems that provide multi-point inspection (MPI) services using multiple automotive data measurement tools.

### BACKGROUND

In recent years, vehicles and the field of automotive maintenance have experienced rapid growth in computerized systems both within automotive vehicles and in computerized diagnostic tools that identify maintenance issues with the vehicles. Modern vehicles include one or more computer systems that are often referred to as an electronic control unit (ECU). In some vehicles, the ECU controls and monitors the operations of numerous systems including, but not limited to, the engine, steering, tires, transmission, brakes, fuel delivery or battery level monitoring, and climate control systems. Some vehicles also include numerous sensors that monitor various aspects of the operation of the vehicle. The ECU receives the sensor data and is configured to generate diagnostic trouble codes (DTCs) if the sensors indicate that one or more systems in the vehicle may be failing or operating outside of predetermined parameters.

Many vehicles use the controller area network (CAN) vehicle bus to transmit data between the ECU and the onboard sensors and components in the vehicle. The CAN bus, or other equivalent data networks in a vehicle, provides a common communication framework between the ECU and the various sensors and systems in the vehicle. Additionally, the CAN bus or equivalent network enables communication between the ECU and external diagnostic tools. Diagnostic tools are also digital computers with communication ports and input/output devices, including display screens and input control buttons, which relay information to a mechanic and enable the mechanic to perform tests and send commands to the ECU. The ECU and diagnostic tools often use an industry standard protocol, such as a version of the on-board diagnostics (OBD) protocol, including the OBD-II protocol. Automotive mechanics and service professionals use a wide range of digital diagnostic tools to interface with the ECUs in vehicles both to diagnose issues with the vehicles, which are often indicated by DTC data from the ECU.

In addition to retrieving DTCs from in-vehicle ECUs, automotive technicians use a wide range of diagnostic equipment to perform inspections and maintenance for vehicles. Many service centers often use different pieces of diagnostic equipment from different manufacturers. The technicians often use the diagnostic and record the results manually during a multi-point inspection For example, a technician uses a battery testing device and a wheel-alignment tester manually during an inspection, and the two devices may be produced by different manufacturers. Some inspection processes seek to collect automotive information for digital storage in a computer system. The process of performing inspection tests and inputting the data into the computer system remains largely manual, however. Some diagnostic tools are configured to transmit results to another computing system for storage, but the data formats and communication protocols for the diagnostic tools of different manufacturers are often incompatible. Additionally, the technician often has to use different and incompatible user interfaces with different diagnostic tools during the MPI, which can increase the inspection time and require additional training for the technicians. Consequently, improvements to the operation of automotive diagnostic systems that enable technicians to perform inspections and other maintenance tasks using multiple diagnostic tools more efficiently would be beneficial.

### SUMMARY

A connected service for automotive diagnostics offers an integration layer that forms a back bone to enable communication and dataflow that will allow technician to perform inspection and store the data in central data storage system. The system optionally includes integration with Electronic multi-point inspection (eMPI) software is. The system includes network services that enable establishment of a connection service framework that is compatible with diagnostic equipment from multiple manufacturers, a secure web administration console that allows both OEM & dealers to configure new equipment, select equipment, scan VIN & view completed results, and integration with equipment vendors based upon a standard web service contract.

In one embodiment, an automotive inspection system includes a plurality of diagnostic tools, each diagnostic tool in the plurality of diagnostic tools being configured to perform a diagnostic procedure on a vehicle, a client computing device, and a server connected to the plurality of diagnostic tools and the client computing device. The server is configured to receive a first command to operate a first diagnostic tool in the plurality of diagnostic tools from the client computing device, transmit the first command to the first diagnostic tool to perform a first diagnostic procedure on the vehicle, receive first diagnostic data from the first diagnostic tool for the first diagnostic procedure, generate a report including the first diagnostic data for the vehicle, and transmit the report to the client computing device to enable an operator of the client computing device to review the first diagnostic data.

In another embodiment, a method of performing an automotive inspection has been developed. The method includes receiving with a server a first command to operate a first diagnostic tool in a plurality of diagnostic tools from a client computing device, transmitting with the server the first command to the first diagnostic tool to perform a first diagnostic procedure on a vehicle, receiving with the server first diagnostic data from the first diagnostic tool for the first diagnostic procedure, generating with the server a report including the first diagnostic data for the vehicle, and transmitting the report from the server to the client computing device to enable an operator of the client computing device to review the first diagnostic data.

### BRIEF DESCRIPTION OF THE DRAWINGS

FIG. 1 is a schematic diagram of a network architecture for collecting, analyzing, and presenting data from different diagnostic tools that are used in multipoint automotive inspections.

FIG. 2 is a schematic diagram of an automotive inspection system where a technician uses one or more diagnostic tools to perform an automotive inspection.

FIG. 3 is a schematic diagram of a system for data collection and analysis from multiple diagnostic tools that retrieve information from a vehicle during a vehicle inspection in conjunction with the system of FIG. 2.

FIG. 4 is a schematic diagram of a web application service that is used with the systems of FIG. 1-FIG. 3.

FIG. 5 is a set of GUI displays depicting stages in an MPI process for an automobile.

FIG. 6 is a graphical user interface (GUI) depiction of automotive diagnostic tools with an interface for connecting via Blue-tooth based protocol to the systems of FIG. 1-FIG. 3.

FIG. 7 is a GUI table that depicts diagnostic test software used with the diagnostic tools from multiple hardware vendors that are registered for use with the systems of FIG. 1-FIG. 3.

FIG. 8 is an illustrative example of a summary report from an MPI of a vehicle that is generated by the systems of FIG. 1-FIG. 3.

FIG. 9 is a diagram including the vehicle inspection system of FIG. 2 and a wireless automotive data collection device that an owner uses to receive initial diagnostic data from a vehicle prior to a full multipoint inspection using the vehicle inspection system.

FIG. 10A is a depiction of a graphical user interface (GUI) used in an automotive inspection system for monitoring a battery in a vehicle.

FIG. 10B is a depiction of a GUI used in an automotive inspection system for monitor tire pressure, treads, and alignment in a vehicle.

FIG. 10C is a depiction of a GUI used in an automotive inspection system for monitoring and viewing results of a battery test diagnostic procedure.

FIG. 11 is a block diagram of a process for performing a multipoint automotive inspection using the system of FIGS. 1-3 and FIG. 9.

### DETAILED DESCRIPTION

For the purposes of promoting an understanding of the principles of the embodiments described herein, reference is now be made to the drawings and descriptions in the following written specification. No limitation to the scope of the subject matter is intended by the references. This patent also includes any alterations and modifications to the illustrated embodiments and includes further applications of the principles of the described embodiments as would normally occur to one skilled in the art to which this document pertains.

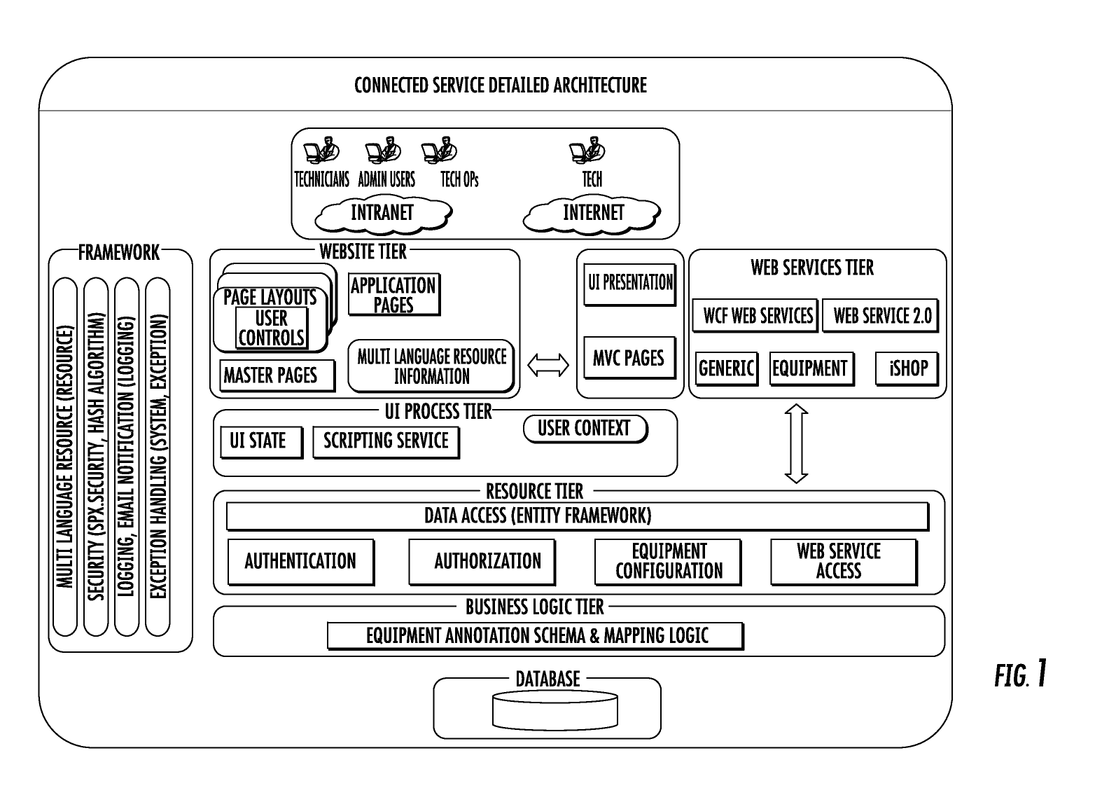

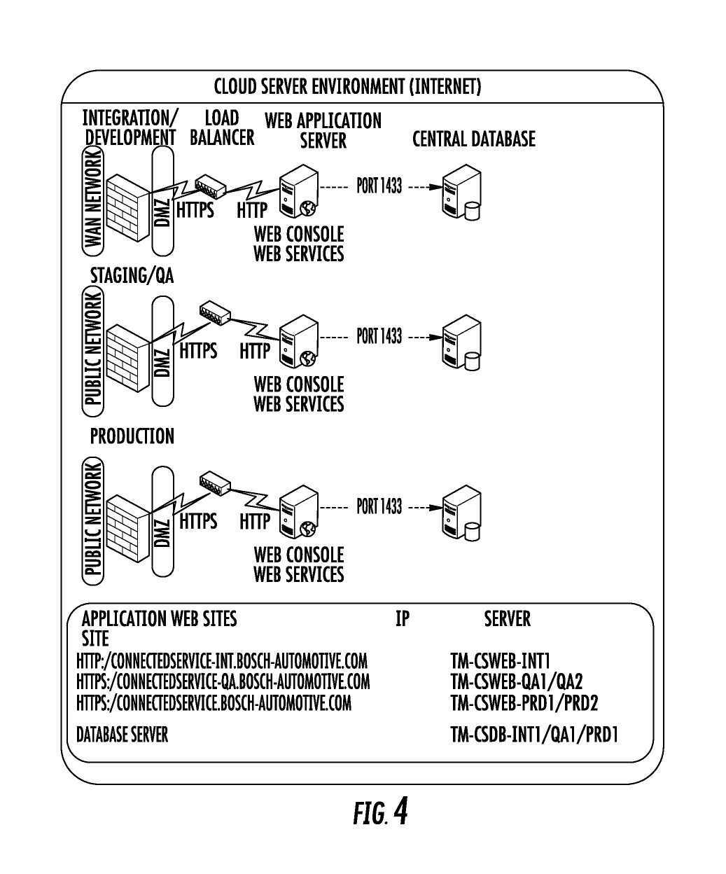

FIG. 1 is a diagram that depicts a network architecture for the collection and analysis of data produced during an automotive multi-point inspection (MPI) process. The system of FIG. 1 includes a network architecture that facilitates the bidirectional communication between automotive technicians with an administrative system that collects MPI and other diagnostic data and optionally generates guidance for the technicians who perform MPI or other automotive maintenance tasks. In particular, the architecture provides for security to authenticate valid users and diagnostic equipment. Additionally, the architecture provides a web-based interface for both technicians and administrators. The architecture of FIG. 1 uses network services that are typically geographically remote from the locations of automotive service centers. One or more data networks, including wired and wireless local area networks (LANs) and wide area networks (WANs) provide communications between the diagnostic equipment and other computing devices in service centers and remotely managed data services. The remotely managed data services are sometimes referred to as “cloud” services and FIG. 4 depicts examples of firewalls and other network devices that provide secure access to network-connected databases using, for example, a web service interface that is compatible with a wide range of computing devices. As described below, the architecture includes services that enable the control and retrieval of data from multiple diagnostic tools that are produced by different manufacturers and are incompatible with each other in prior art systems. In the diagram of FIG. 1, the Equipment Annotation Schema and Business Logic provides translation and mapping services to provide compatibility with a wide range of diagnostic equipment.

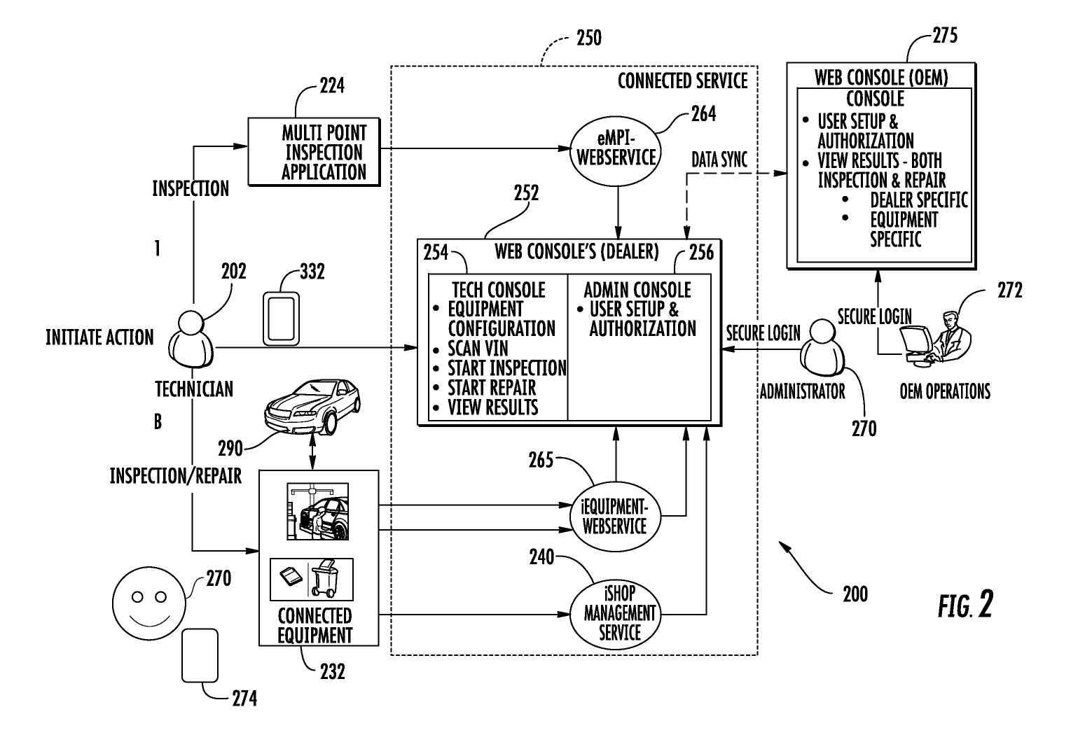

FIG. 2 depicts an automotive inspection system 200 that includes a network-based automotive inspection and analysis server 250. The server 250 includes a web console 252 that is implemented as a web server or other suitable network service that can be accessed using appropriate client software applications using a personal computer (PC), smartphone, tablet, or other mobile computing device. In the embodiment of FIG. 2, the server 250 is embodied as a server computing device, or optionally a cluster of multiple server computing devices, that implements a part ordering (“iShop”) management web service 240, a web console 252 with a web server, an MPI web service 264, and an equipment management web service (iEquipment) 265. The web console 252 includes a technological console 254 that provides a graphical user interface (GUI) and graphical control elements to enable a client computing device 332 to control automotive diagnostic and maintenance tools including, but not limited to, tire pressure sensor (TPS), wheel alignment, battery tester, and on-board diagnostic computer analysis tools. The diagnostic tools are often manufactured by different companies and conform to different data interchange formats and network communication and control protocols. In the system 200, the technological console 254 is configured with a broad compatibility layer that enables the web console 252 to receive data from the diagnostic tools from multiple manufacturers. Additionally, in some embodiments the tech console 254 is configured to send commands to diagnostic tools to control the operation of the diagnostic tools in an automated or semi-automated manner to improve the efficiency of an MPI process.

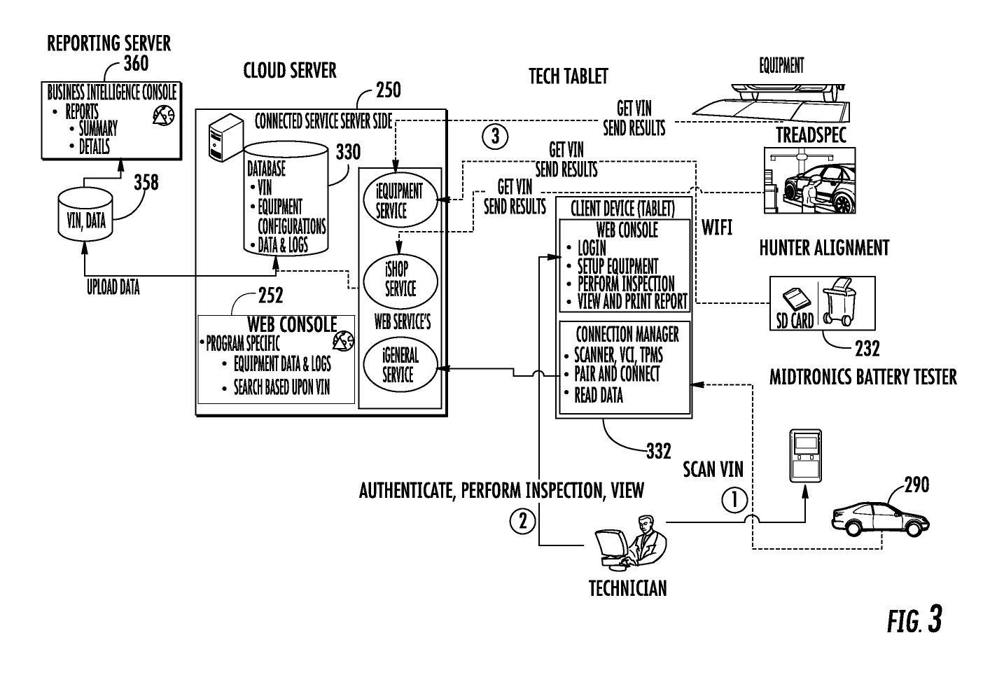

In FIG. 2, a technician 202 uses a client computing device 332 that executes a software application 224 or the technician accesses a network inspection/repair interfaces in the diagnostic tools 232 with the client computing device to perform a multi-point inspection on a vehicle using the MPI and iEquipment web services from the server 250. The client computing device 332 is, for example, a mobile telephone, tablet computer, or personal computer (PC) that implements a web browser or other suitable client software program to send commands to the server 250 to operate the diagnostic tools 232 and to receive reports including vehicle diagnostic data from the server 250. In one embodiment, the tech console 254 receives the vehicle identification number (VIN) from the technician 202 using, for example, a bar-code reader, a diagnostic tool that retrieves the VIN from the vehicle ECU, or from manual entry of the VIN. The tech console 254 uses the VIN as an identifier for the make and model of the vehicle that is stored in a database (e.g. database 330 in FIG. 3) and identifies the types of connected diagnostic equipment 232 that are associated with the service center where the technician 202 performs the MPI. While an MPI process is described for illustrative purposes, the server 250 optionally controls the diagnostic equipment 232 and presents information to the technician 202 during a vehicle maintenance or repair process in a similar manner to the MPI process.

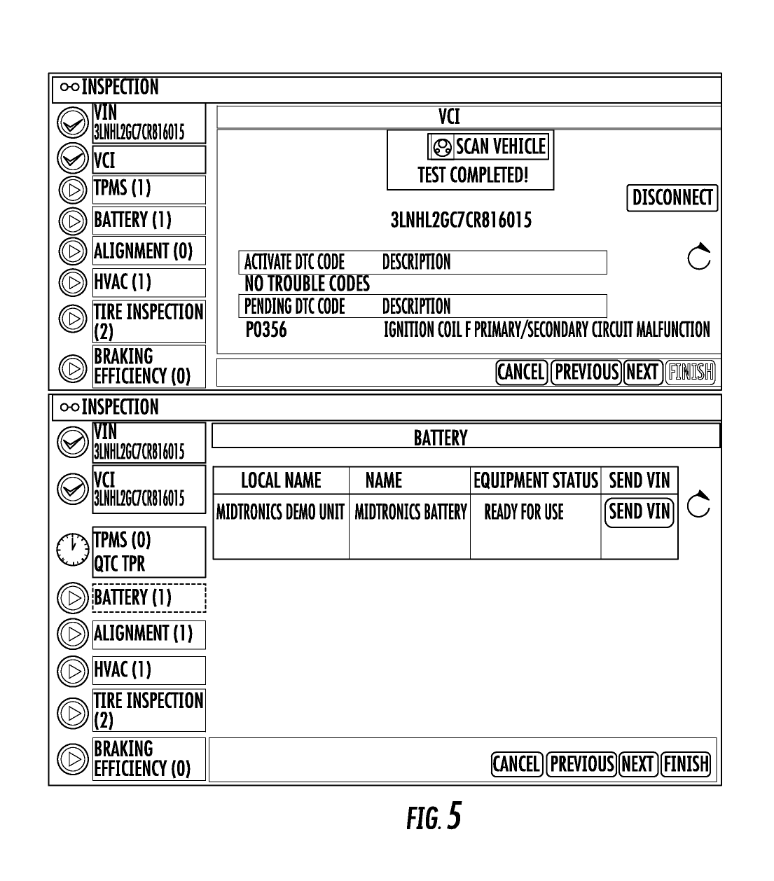

After identifying the make and model of the vehicle, the tech console 254 generates a web-based interface for the technician to perform the MPI of the vehicle using the diagnostic equipment 232. The interface is optionally customized for the make and model of the vehicle that is undergoing inspection to accommodate different features of different vehicle models. In one embodiment, the technician uses a PC, smartphone, tablet based computer or other suitable computing device to view a graphical user interface (GUI) that guides the technician through the MPI process. FIG. 5 depicts two illustrative examples of GUI displays that are generated during the MPI process. The technician 202 connects the diagnostic tools 232 to the vehicle in response to instructions from the MPI GUI.

In one embodiment, the technician is only required to connect a diagnostic tool to the vehicle but is not required to perform complex operations with the diagnostic tool because the tech console 254 is configured to operate the diagnostic tool remotely. For example, in one embodiment the technician 202 connects a battery testing device to the electrical terminals of a vehicle battery, but the technician does not have to read or interpret test results from the battery tester. Instead, the tech console 254 retrieves the information directly from the battery tester via a wired data network, such as Ethernet, or a wireless data network, such as a Bluetooth or IEEE 802.11 wireless network. The server 250 implements network services that are compatible with a wide range of automotive testing equipment from multiple vendors to enable different service centers to use the server 250 with a wide range of testing equipment. For example, in the illustrative embodiment of FIG. 2 the web console 252 receives data from the connected diagnostic equipment 232 using the “iEquipment Web service” and the “iShop Management” web service 240, although the server 250 can be configured for other standards as well. The tech console 254 generates a message with the GUI that indicates that the test is completed and that prompts the technician 202 to proceed with other parts of the inspection or repair process.

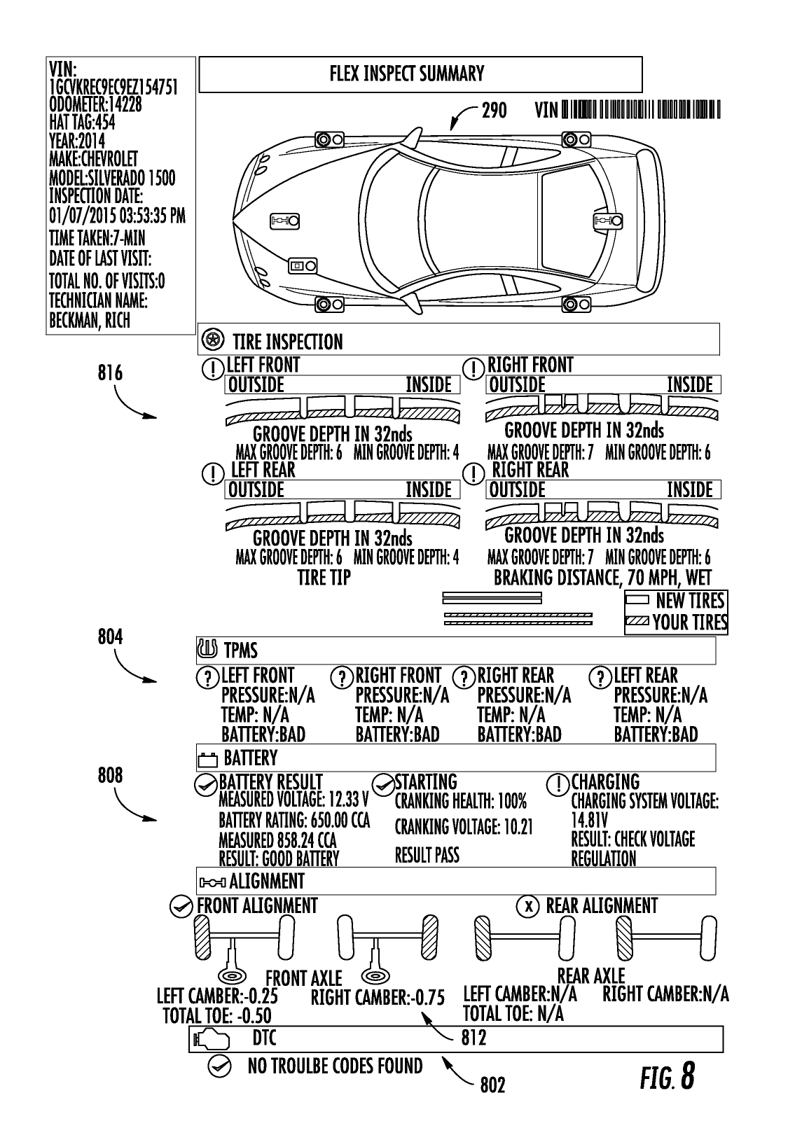

FIG. 8 depicts an example of a report that is generated from the MPI process in the server 250. The report in FIG. 8 includes specific information about the vehicle based on the retrieved VIN information and the results of test from various diagnostic equipment tests including tire pressure, battery, and wheel alignment tests. For example, FIG. 8 depicts a graphical depiction of the vehicle 290. In some embodiments of the system 200, the server 250 uses the VIN for the vehicle 290 to retrieve a graphic that corresponds to the configuration of the vehicle (e.g. shape of vehicle, number of doors, etc.) to provide a more accurate depiction of the vehicle in the report. The report in FIG. 8 also includes a list 802 of DTCs identified during the inspection process, a set of tire pressure measurement data 804, battery monitoring data 808 including a battery voltage measurement, wheel alignment information 812, and tire tread depth data 816. In the system 200, different diagnostic tools perform the diagnostic processes to generate the report data. The server 250 in the diagnostic analysis server 250 receives the report data from the different diagnostic tools and generates a formatted report that incorporates the data from each of the different diagnostic procedures. In the system 200, the server 250 implements web services to produce the report as a hypertext markup language (HTML) document, a portable document format (PDF) document, or any other document format that is suitable for display using the client computing device 332 and the electronic communication device 274 that is associated with the vehicle owner 270.

In another operating mode, the server 250 receives data from a commercially available multi-point inspection application 224. The MPI application 224 is a software program that typically collects diagnostic inspection data manually from the technician as the technician 202 performs a manual MPI inspection of the vehicle. The server 250 executes stored program instructions to implement the eMPI Web-service 264 and iEquipment control web service 265 that are compatible with the report formats from existing MPI application programs 224. The server 250 also provides diagnostic tool command and data retrieval through the iEquipment web service 265 to enable the client computing device 332 to send commands to the plurality of diagnostic tools 232 and receive results from the diagnostic procedures that the diagnostic tools 232 perform on the vehicle 290. The web console 252 receives compatible MPI data from the MPI web service 264 to accommodate service centers that use the existing commercial MPI software instead of the automated MPI and maintenance processes that are implemented by the server 250.

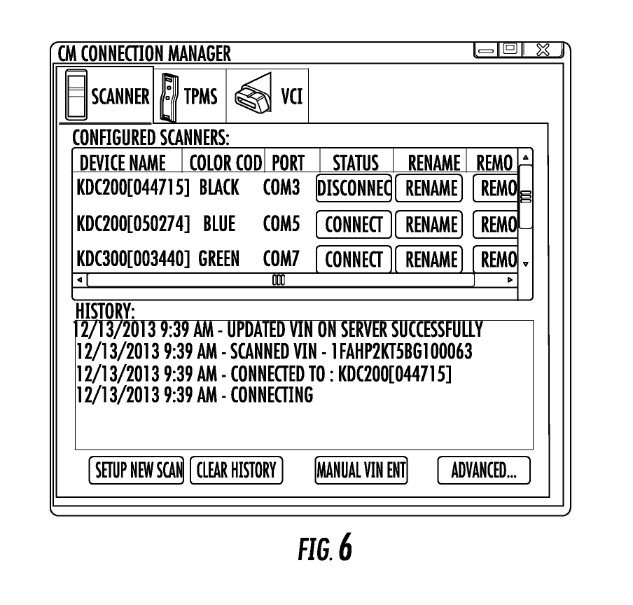

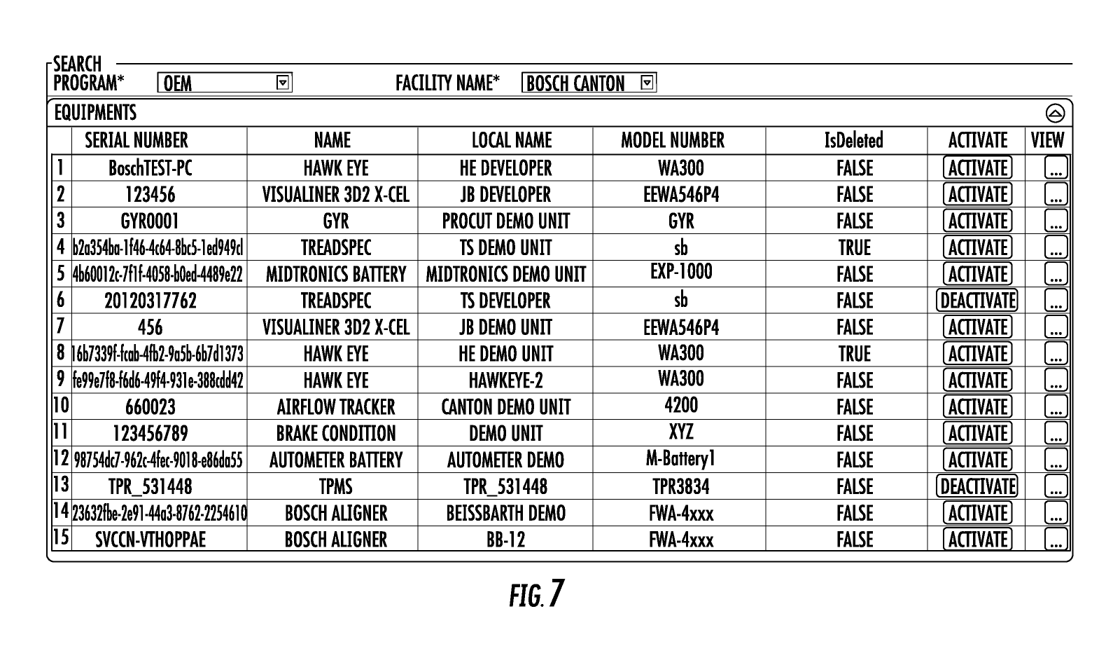

In the server 250, an administrator 270 reviews MPI report data and other diagnostic information that the web console 252 stores using an administrative console 256. The administrator 270 also controls the authorization and registration of specific pieces of diagnostic equipment 232 for use with the server 250 using the equipment serial and model numbers that are typically stored in a non-volatile memory in each piece of equipment, and a vendor token that is used for authentication and authorization of different accounts with the server 250. An individual account corresponds to, for example, a service center, a chain of multiple service centers, or to an individual technician in different configurations of the server 250. The administrative console 256 provides registration information about the connected diagnostic equipment 232 and software services that are registered with the server 250. For example, FIG. 6 depicts a GUI interface that identifies different diagnostic tools and enables an administrator to review the usage history of the devices and to register or remove diagnostic tools from the server 250. FIG. 7 depicts another GUI that displays identifiers for different software products and services that are registered for use in the server 250. Different vendors, including automotive manufacturers and automotive part suppliers, can provide software services that are compatible with the server 250 in a modular manner. Different service centers can select different software modules for use based on the diagnostic equipment in use and types of vehicles that receive MPIs and other maintenance at the service centers.

In addition to the administrator 270, the server 250 provides aggregate MPI information to original equipment manufacturers (OEMs) 272. The OEMs 272 retrieve the MPI data from the server 250 through an OEM web console 275, and a network-based service aggregates MPI information from multiple service centers to enable the OEM 272 to review MPI and other diagnostic information from multiple service centers. The OEMs 272 include, for example, the vehicle manufacturers and part suppliers that provide replacement parts to service centers.

FIG. 3 is an illustrative example of the system 200 including additional elements in the server 250 and interaction during an MPI process that is performed with the systems of FIG. 1 and FIG. 2. In FIG. 3, a technician retrieves the VIN from the vehicle and uses a diagnostic tool or a computing device, such as a PC, tablet, or smartphone, to transmit the VIN to the server 250. The server 250 generates a GUI for the technician that provides an interface for performing an MPI or another maintenance operation. The server 250 identifies specific information about the vehicle using the VIN and retrieves specific information about the diagnostic tools that are registered for use with the technician from a database 330.

The technician uses a client computing device 332, such as a PC, smartphone, or tablet, to interact with the user interface that is provided by the web console 252. The technician typically performs an authentication “login” process to access the system 252 prior to performing the MPI. In the configuration of FIG. 3, the client device 332 also receives diagnostic data from one or more of the diagnostic tools and from the ECU in the vehicle 290 that is undergoing the MPI. The web services in the server 250 provide a GUI that the technician views using the client device 332, and the client device 332 receives data from the diagnostic tools 232 and from technician input via a touchscreen or other data input device.

The server 250 stores the result data from the MPI in the database 330. In some instances, when a single vehicle visits one or more service centers that share access to the database 330, the stored information provide vehicle maintenance history information to the technician. The server 250 transmits portions of the information in the database 330 to external databases, such as the external database 358, to provide access to aggregate information to third-parties via a business intelligence console 360. Examples of third-parties include automotive manufacturers and part supplier OEMs. The business intelligence console 360 provides aggregate information about the overall activity of one or more service centers to the third-parties. The database 358 optionally receives only portions of the VIN data that correspond to general makes and models of vehicles while portions of the VIN data that identify individual vehicles are not available to the business logic console 360.

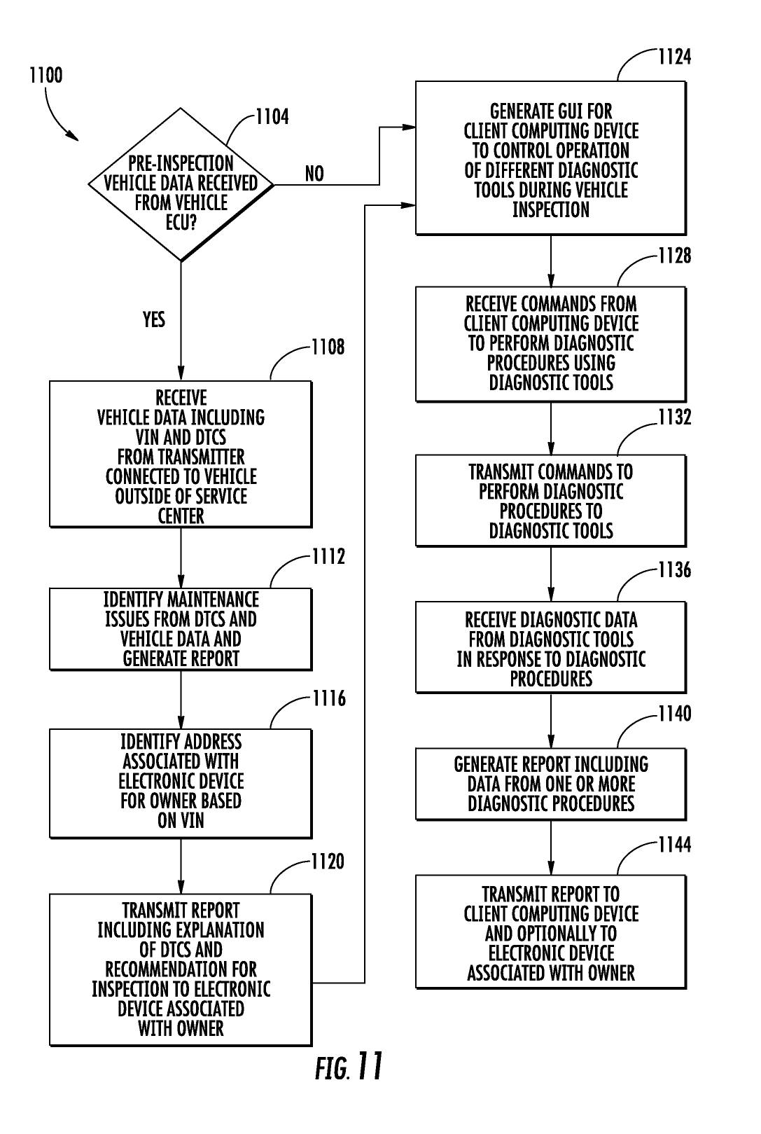

FIG. 11 depicts a block diagram of a process 1100 for performing an automotive inspection using the automotive inspection system embodiments described above. In the discussion below, a reference to the process 1100 performing a function or action refers to the execution of stored program instructions by one or more processors to perform the function or action using other components in the automotive inspection system. Process 1100 is described in conjunction with the automotive inspection system embodiments of FIG. 1-FIG. 3 and FIG. 9 for illustrative purposes.

Process 1100 begins as the system 200 receives an optional pre-inspection vehicle from a motor vehicle prior to commencement of a full multipoint inspection process (block 1104). Other embodiments of the process 1100 omit the pre-inspection vehicle data collection and report process, and the process 1100 continues as described in more detail with reference to the processing of block 1124 below.

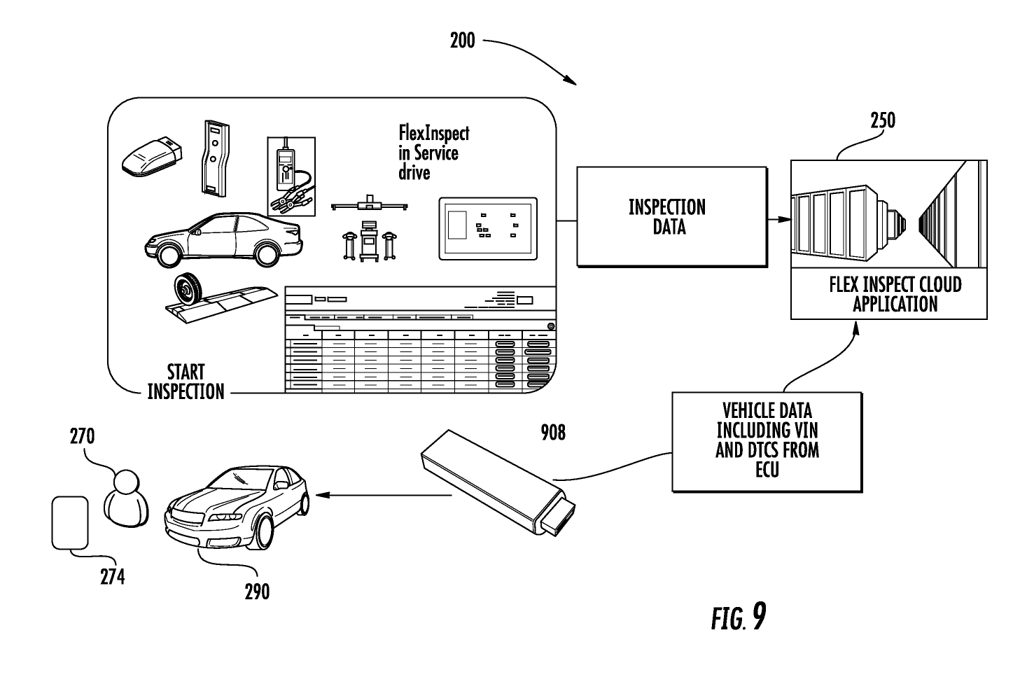

During process 1100, the As illustrated in FIG. 9, the owner 270 or other party with access to the vehicle 904 uses a vehicle data collection and transmission device 908 to receive vehicle information from an electronic control unit (ECU) in the vehicle. The vehicle data include, but are not necessarily limited to, operational parameters and history of components in the vehicle from in-vehicle sensors, the vehicle identification number (VIN) for the vehicle 904, and a list of diagnostic trouble codes (DTCs) that indicate potential maintenance issues with the vehicle 904. In the embodiment of FIG. 9, the vehicle data collection and transmission device 908 receives the data from the ECU through an OBD-II port or other suitable data interface in the vehicle 904. The vehicle data and transmission device 908 includes a transmitter that transmits the collected vehicle data to the server 250 either directly through a wireless local area network (WLAN) or wireless wide area network (WWAN) connection, or through another electronic communication device 274 that is associated with the owner 270, such as a mobile telephone, tablet computing device, or PC. In the embodiment of FIG. 9, the server 250 receives the vehicle data in the form of a web service request that includes an encoded version of the information that the vehicle data and transmission device 908 extracts from the vehicle 904 (block 1108).

Process 1100 continues as the server 250 identifies potential maintenance issues with the vehicle 904 based on DTCs and other vehicle information received from the vehicle data and transmission device 908 (block 1112). In the system 200, the server 250 accesses the database 330 that stores diagnostic trouble code data to enable the server 250 to identify potential maintenance issues that correspond to different DTCs. In some embodiments, the server 250 specifies the make, model, and year of the vehicle 904 using the VIN data to identify specific maintenance issues that have occurred in vehicles with a similar make, model, and year. The server 250 generates a report corresponding to the DTCs and other vehicle information corresponding to the vehicle 904. The report includes, for example, an explanation of the DTC codes for the user 270 and a recommendation to bring the vehicle 904 to a service center for a more detailed inspection if necessary. In the illustrative embodiment of FIG. 2, the server 250 is a web server that produces the report in a formatted document, such as a hypertext markup language (HTML) document, portable document format (PDF), or other suitable document format to enable the user 270 to view the report using a web browser using the electronic communication device 274.

Process 1100 continues as the server 250 identifies an address that is associated with the electronic communication device 274 (block 1116). The server 250 identifies the address in a user registration information in the database 330 that associates the VIN from the vehicle 904 with the user 270. The address is, for example, an email address, telephone number, or social media account name that the user 270 uses for communication with the electronic communication device 274. The user 270 optionally performs a registration process if the server 250 fails to identify a suitable address that is associated with the VIN from the vehicle 904. The server 250 transmits the report to the electronic communication device, such as the mobile telephone 274, that is associated with the user 270 (block 1120). In the system 200, the server 250 transmits the report to the address that is associated with the mobile telephone 274, or another electronic communication device associated with the user 270 such as a tablet or personal computer.

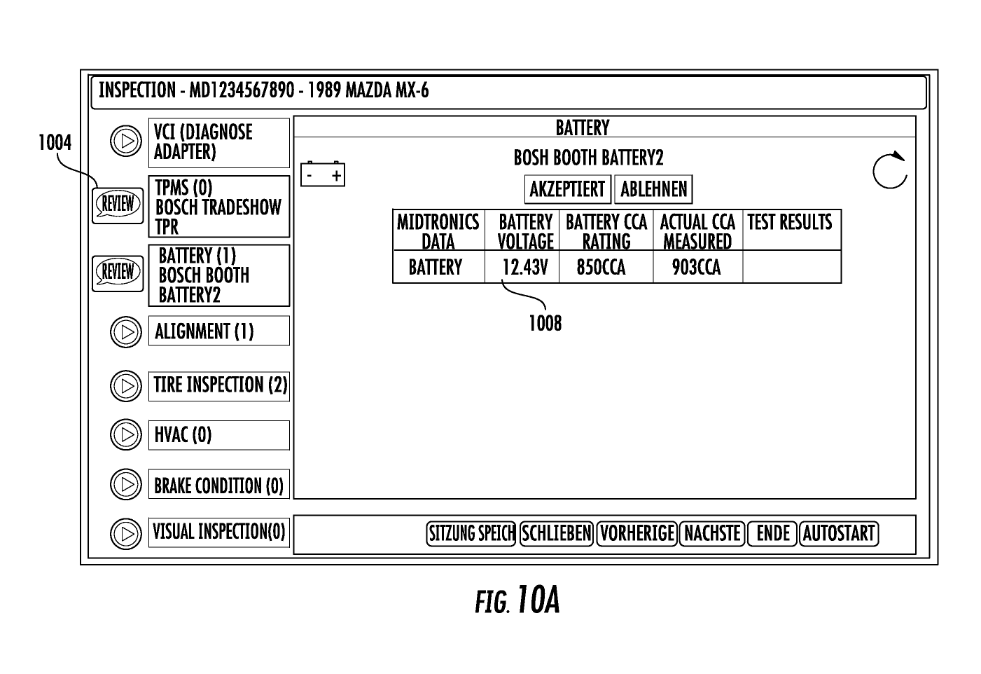

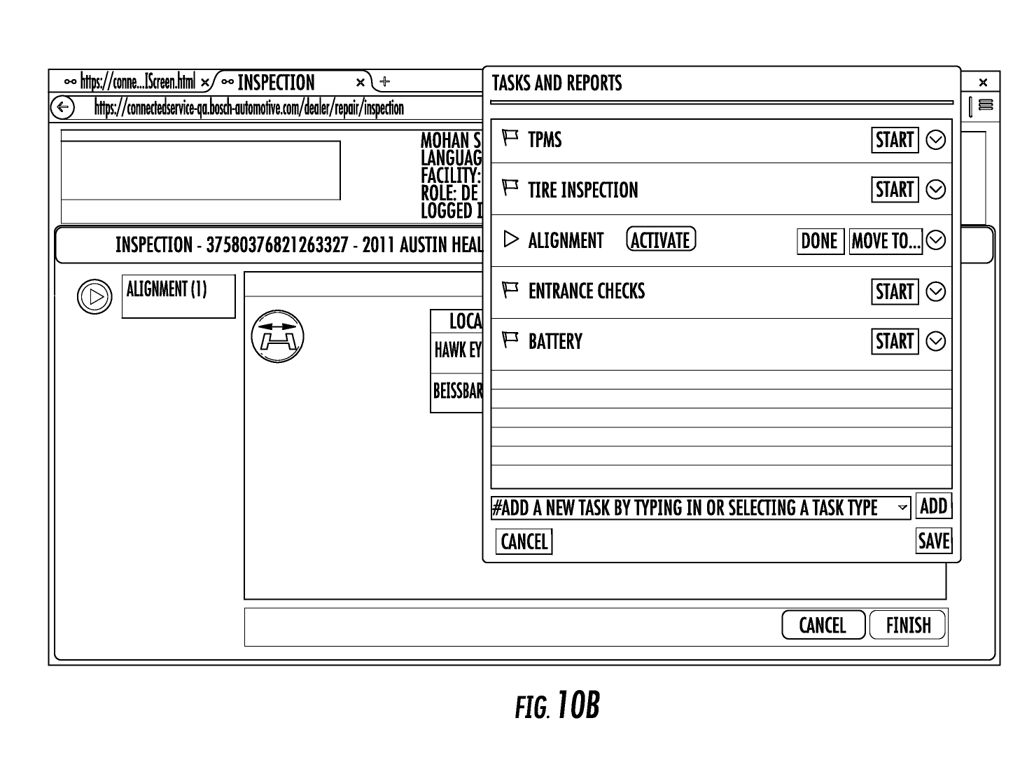

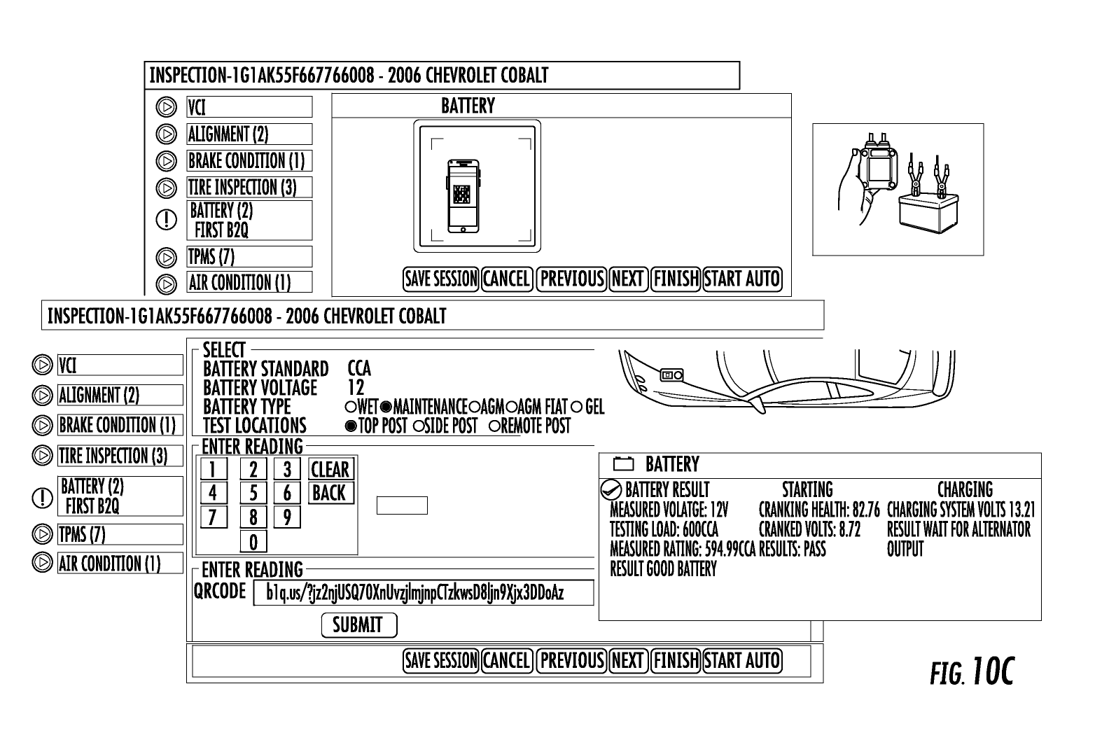

Process 1100 continues with the multipoint inspection process that occurs when the vehicle 904 travels to a service center with the diagnostic system 200. In the system 200, the server 250 generates a GUI for the client computing device 332 (block 1124). The server 250 generates the GUI including control elements for each of the plurality of diagnostic tools 232. For example, if the diagnostic tools 232 include a battery monitor and a tire pressure monitor, the server 250 generates a GUI including controls to perform a battery and tire pressure monitoring procedures. In one embodiment, the server 250 is configured with a plurality of registered diagnostic tools and the server 250 generates the GUI including controls for each of the registered devices. In the system 200, the server 250 implements a web service that produces one or more HTML pages to implement the GUI through the tech console 254. The client computing device 332 receives the tech console GUI 254 from the server 250 and executes a web browser or other software application view the GUI. FIG. 10A depicts a GUI for the battery monitor test including a control element 1004 to view or repeat a battery monitoring procedure. The GUI also depicts results of the battery monitoring test including a battery voltage display. FIG. 10B depicts GUI controls for operating a tire pressure monitoring and alignment test device. In an MPI embodiment where the system 200 performs multiple diagnostic procedures, the client computing device 332 presents graphical controls and displays results for each of the diagnostic procedures that are part of the MPI process.

During process 1100, the technician 202 uses the client computing device 332 to view the GUI and enter commands to operate the diagnostic tools. In the system 200, the client computing device 332 receives user input to execute a command and the server 250 receives the commands to perform diagnostic procedures that are transmitted from the client computing device 332 as web service requests (block 1128). The server 250 then transmits the command to one of the plurality of diagnostic tools 232 (block 1132). In some embodiments, the server 250 translates the command from a web service request that is received from the client computing device 332 into a different command protocol that is compatible with the selected diagnostic tool to perform the command. FIG. 5-FIG. 7 and FIG. 10A-FIG. 10C depict illustrative examples of GUI displays in the system 200.

Process 1100 continues as the server 250 receives transmissions from the diagnostic tools 232 in response to performing the diagnostic procedures on the vehicle 290 (block 1136). As described above, the diagnostic tools 232 transmit the diagnostic data to the server 250 through a wired or wireless data network. In many embodiments, at least one of the diagnostic tools 232 retrieves the VIN from the ECU in the vehicle 290, and the server 250 receives the VIN for the vehicle 290 in addition to other diagnostic data from the diagnostic tools 232. The analysis system 250 stores the diagnostic data in the database 330 as part of a vehicle history data in association with the VIN from the vehicle 290. In some embodiments, the technician also enters a request to order a new part for the vehicle 290 though the iShop web service 240.

After performing one or more diagnostic procedures, the system 200 generates a report that includes diagnostic data from at least one of the diagnostic procedures (block 1140). As describe above, FIG. 8 depicts a display of a report that includes diagnostic data from multiple diagnostic tools that perform multiple diagnostic procedures are part of an MPI, and the server 250 optionally generates the report including a graphical depiction of the vehicle that corresponds to the actual shape of the vehicle using the VIN to identify an appropriate graphic in the database 330 for the vehicle 290.

During process 1100, the server 250 transmits the report to the client computing device 332 and optionally to the electronic communication device 274 that is associated with the vehicle owner 270 (block 1144). In the server 250, the web console 252 transmits the report to the client computing device 332 to enable the technician 202 to use a web browser or other user software to review the full MPI report to diagnose issues with the vehicle 290 and to report on maintenance work that has been completed for the vehicle 290. The server 250 optionally identifies the address of the user account that is associated with the electronic communication device 274 and transmits the report to the electronic communication device 274 to enable the user 270 to review the report directly.

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. An automotive inspection system comprising:
a plurality of diagnostic tools, each diagnostic tool in the plurality of diagnostic tools being configured to perform a diagnostic procedure on a vehicle;
a client computing device; and
a server connected to the plurality of diagnostic tools and the client computing device, the server being further configured to:
receive a first command to operate a first diagnostic tool in the plurality of diagnostic tools from the client computing device;
transmit the first command to the first diagnostic tool to perform a first diagnostic procedure on the vehicle;
receive first diagnostic data from the first diagnostic tool for the first diagnostic procedure;
generate a report including the first diagnostic data for the vehicle; and
transmit the report to the client computing device to enable an operator of the client computing device to review the first diagnostic data.

2. The system of claim 1, the server being further configured to:
receive a second command to operate a second diagnostic tool in the plurality of diagnostic tools from the client computing device, the second diagnostic tool being different than the first diagnostic tool;
transmit the second command to the second diagnostic tool to perform a second diagnostic procedure on the vehicle;
receive second diagnostic data from the second diagnostic tool for the second diagnostic procedure;
generate the report including the first diagnostic data and the second diagnostic data for the vehicle; and
transmit the report to the report to the client computing device to enable the operator of the client computing device to review the first diagnostic data and the second diagnostic data in the report.

3. The system of claim 2, the server being further configured to:
transmit the first command to a tire pressure measurement diagnostic tool;
receive the first diagnostic data from the tire pressure measurement diagnostic tool including a tire pressure measurement for at least one tire in the vehicle;
transmit the second command to a battery monitor diagnostic tool;
receive the second diagnostic data from the battery monitor diagnostic tool including a measured voltage level of a battery in the vehicle; and
generate the report including the tire pressure measurement of the at least one tire and the battery voltage level of the battery in the vehicle.

4. The system of claim 1, the server being further configured to:
receive a vehicle identification number (VIN) and vehicle information data from an electronic control unit (ECU) in the vehicle from a transmitter operatively connected to the vehicle prior to receiving the first command to operate a first diagnostic tool in the plurality of diagnostic tools from the client computing device;
identify a diagnostic trouble code (DTC) in the vehicle information data;
identify an address of an electronic communication device associated with an owner of the vehicle with reference to the VIN; and
transmit a message to the electronic communication device associated with the owner including an explanation of the DTC with reference to the address.

5. The system of claim 1, the server being further configured to:
generate a graphical user interface (GUI) including graphical control elements for a predetermined set of diagnostic procedures performed by the plurality of diagnostic tools;
transmit the GUI to the client computing device; and
receive the first command to operate the first diagnostic tool from the client computing device in response to user input to select a graphical control element associated with the first diagnostic procedure in the GUI.

6. The system of claim 1, the server being configured to:
receive a vehicle identification number (VIN) associated with the vehicle from the first diagnostic tool;
identify a graphical representation of the vehicle with reference to the VIN; and
generate the report including the graphical representation of the vehicle.

7. The system of claim 1 wherein the server implements a web service configured to receive the first command from the client computing device as a first web service request, receive the first diagnostic data from the first diagnostic tool in response to a second web service request, and generate the report in using a hypertext markup language (HTML) format.

8. The system of claim 1, the server being further configured to:
receive a vehicle identification number (VIN) from the first diagnostic tool;
identify an address of an electronic communication device associated with an owner of the vehicle with reference to the VIN; and
transmit the report to the electronic communication device associated with the owner.

9. The system of claim 1 wherein the client computing device is one of a mobile telephone, tablet computing device, or personal computer.

10. A method of performing an automotive inspection comprising:
receiving with a server a first command to operate a first diagnostic tool in a plurality of diagnostic tools from a client computing device;
transmitting with the server the first command to the first diagnostic tool to perform a first diagnostic procedure on a vehicle;
receiving with the server first diagnostic data from the first diagnostic tool for the first diagnostic procedure;
generating with the server a report including the first diagnostic data for the vehicle; and
transmitting with the server the report to the client computing device to enable an operator of the client computing device to review the first diagnostic data.

11. The method of claim 10 further comprising:
receiving with the server a second command to operate a second diagnostic tool in the plurality of diagnostic tools from the client computing device, the second diagnostic tool being different than the first diagnostic tool;
transmitting with the server the second command to the second diagnostic tool to perform a second diagnostic procedure on the vehicle;
receiving with the server the second diagnostic data from the second diagnostic tool for the second diagnostic procedure;
generating with the server the report including the first diagnostic data and the second diagnostic data for the vehicle; and
transmitting with the server the report to the report to the client computing device to enable the operator of the client computing device to review the first diagnostic data and the second diagnostic data in the report.

12. The method of claim 11 further comprising:
transmitting with the server the first command to a tire pressure measurement diagnostic tool;
receiving with the server the first diagnostic data from the tire pressure measurement diagnostic tool including a tire pressure measurement for at least one tire in the vehicle;
transmitting with the server the second command to a battery monitor diagnostic tool;
receiving with the server the second diagnostic data from the battery monitor diagnostic tool including a measured voltage level of a battery in the vehicle; and
generating with the server the report including the tire pressure measurement of the at least one tire and the battery voltage level of the battery in the vehicle.

13. The method of claim 10 further comprising:
receiving with the server a vehicle identification number (VIN) and vehicle information data from an electronic control unit (ECU) in the vehicle from a transmitter operatively connected to the vehicle prior to receiving the first command to operate a first diagnostic tool in the plurality of diagnostic tools from the client computing device;
identifying with the server a diagnostic trouble code (DTC) in the vehicle information data;
identifying with the server an address of an electronic communication device associated with an owner of the vehicle with reference to the VIN; and
transmitting a message to the electronic communication device associated with the owner including an explanation of the DTC with reference to the address.

14. The method of claim 10 further comprising:
generating with the server a graphical user interface (GUI) including graphical control elements for a predetermined set of diagnostic procedures performed by the plurality of diagnostic tools;
transmitting with the server the GUI to the client computing device; and
receiving with the server the first command to operate the first diagnostic tool from the client computing device in response to user input to select a graphical control element associated with the first diagnostic procedure in the GUI.

15. The method of claim 10 further comprising:
receiving with the server a vehicle identification number (VIN) associated with the vehicle from the first diagnostic tool;
identifying with the server a graphical representation of the vehicle with reference to the VIN; and
generating with the server the report including the graphical representation of the vehicle.

16. The method of claim 10 further comprising:
receiving with the server a vehicle identification number (VIN) from the first diagnostic tool;
identifying with the server an address of an electronic communication device associated with an owner of the vehicle with reference to the VIN; and
transmitting with the server the report to the electronic communication device associated with the owner.

17. The method of claim 10 further comprising:
implementing a web service with the server to receive the first command from the client computing device as a first web service request;
receiving with the web service the first diagnostic data from the first diagnostic tool in response to a second web service request from the first diagnostic tool; and
generating with the web service the report in using a hypertext markup language (HTML) format.
